(19) United States
(12) Patent Application Publication
(10) Pub. No.: US 2018/0157912 A1
(43) Pub. Date: Jun. 7, 2018

(54) AGRICULTURAL PRODUCT DETECTION DEVICE, AGRICULTURAL PRODUCT MANAGEMENT SYSTEM AND METHOD THEREOF

(71) Applicant: INSTITUTE FOR INFORMATION INDUSTRY, Taipei (TW)

(72) Inventors: Chien-Der LIN, Kaohsiung City (TW); Chin-Shun HSU, Kaohsiung City (TW); Yung-Hsing PENG, Kaohsiung City (TW); Po-Cheng HUANG, Yunlin County (TW)

(21) Appl. No.: 15/373,384

(22) Filed: Dec. 8, 2016

(30) Foreign Application Priority Data
Dec. 2, 2016 (TW) 105139989

(51) Int. Cl. G06K 9/00; G01B 7/28; G01J 3/50; G01L 1/20; G01G 19/52; G01S 17/02; A41D 19/00; A41D 1/00; A01G 1/00; G06N 99/00; G06N 7/00; G06T 7/90

(52) U.S. Cl. CPC G06K 9/00657; G01B 7/28; G01J 3/50; G01L 1/20; G01G 19/52; G01S 17/026; G06K 2209/17; A41D 1/005; A01G 1/001; G06N 99/005; G06N 7/005; G06T 7/90; G06T 2207/10024; A41D 19/0027

(57) ABSTRACT

An agricultural product detection device, an agricultural product management system and a method thereof are provided. The agricultural product detection device includes at least one flex sensing unit, at least one color sensing unit and a processing unit. The flex sensing unit is configured to perform shape sensing on an agricultural product, so as to obtain curvature information of the agricultural product. The color sensing unit is configured to perform color sensing on the agricultural product, so as to obtain color information of the agricultural product. The processing unit is configured to perform an operation process on the curvature information and the color information and to generate an operation process result accordingly.

### RELATED APPLICATIONS

This application claims priority to Taiwanese Application Serial Number 105139989, filed on Dec. 2, 2016, which is herein incorporated by reference.

### BACKGROUND

### Field of the Invention

The invention relates to agricultural product detection and management, and more particularly to an agricultural product detection device, an agricultural product management system and a method thereof.

### Description of Related Art

Agricultural products are usually classified into several levels and are treated by corresponding following treatments, such as packaging and processing after being harvested in response to market requirements. On the other hand, an operating personnel usually verifies quality of agricultural products by his sensory organs, such as eyes, nose and hands when determining if the agricultural products can be harvested and classifying the harvested agricultural products. However, the criteria for such artificially verification method would vary along with the experience and status of an operating personnel, environment and time, which results in inconsistency of agricultural product quality classification accuracy.

### SUMMARY

The objective of the invention is to provide a method and apparatus for wireless communications. By utilizing the method and apparatus of the invention, the state transition time of a secondary component carrier of a mobile terminal exiting the activation state and back to the activation state again can be reduced, and the efficiency of spectrum resource usage can be effectively improved.

One aspect of the invention is to provide an agricultural product detection device which includes at least one flex sensing unit, at least one color sensing unit and a processing unit. The flex sensing unit is configured to perform shape sensing on an agricultural product to obtain curvature information of the agricultural product. The color sensing unit is configured to perform color sensing on the agricultural product to obtain color information of the agricultural product. The processing unit is coupled to the flex sensing unit and the color sensing unit and is configured to perform an operation process on the curvature information and the color information and to generate an operation process result accordingly.

In accordance with one or more embodiments of the invention, the processing unit is configured to determine a category to which the agricultural product belongs based on the operation process result and a grading rule information corresponding to the agricultural product.

In accordance with one or more embodiments of the invention, the agricultural product detection device further includes a glove base which is adapted to be worn on a hand of a user. The flex sensing unit, the color sensing unit and the processing unit are arranged in the glove base.

In accordance with one or more embodiments of the invention, the agricultural product detection device further includes a pressure sensing unit which is configured to perform weight sensing on the agricultural product to obtain weight information of the agricultural product, and the processing unit is configured to perform the operation process on the curvature information, the color information and the weight information to generate the operation process result accordingly.

In accordance with one or more embodiments of the invention, the agricultural product detection device further includes a notification unit which is configured to indicate the curvature information, the color information or the operation process result.

In accordance with one or more embodiments of the invention, the agricultural product detection device further includes a data storage unit which is configured to store the curvature information, the color information or the operation process result.

Another aspect of the invention is to provide an agricultural product management system which includes an agricultural product detection device and an information processing device. The agricultural product detection device includes at least one flex sensing unit, at least one color sensing unit and a detection device communication unit. The flex sensing unit is configured to perform shape sensing on agricultural products to obtain curvature information of each of the agricultural products. The color sensing unit is configured to perform color sensing on the agricultural products to obtain color information of each of the agricultural products. The detection device communication unit is configured to transmit the curvature information and the color information of each of the agricultural products. The information processing device includes a processing device communication unit and a processing unit. The processing device communication unit is configured to be communicatively connected with the detection device communication unit and to receive the curvature information and the color information from the agricultural product detection device. The processing unit is configured to receive the curvature information and the color information of each of the agricultural products and to perform an operation process on the curvature information and the color information of each of the agricultural products and to generate an operation process result accordingly.

In accordance with one or more embodiments of the invention, the processing unit is configured to determine a category to which each of the agricultural products belongs among a plurality of categories based on the operation process result and grading rule information corresponding to the agricultural products.

In accordance with one or more embodiments of the invention, the processing unit is configured to generate shape information and maturity information of each of the agricultural products based on the operation process result and to record the shape information and the maturity information of each of the agricultural products.

In accordance with one or more embodiments of the invention, the agricultural product detection device further includes a pressure sensing unit which is configured to perform weight sensing on the agricultural products to obtain weight information of each of the agricultural products. The processing unit is further configured to perform the operation process on the at least one curvature information, the at least one color information and the weight information of each of the agricultural products and to generate the operation process result accordingly.

In accordance with one or more embodiments of the invention, the agricultural product detection device includes two glove bases which are adapted to be respectively worn on two hands of the user. The flex sensing unit is arranged in at least one of the glove bases, and the color sensing unit is arranged in at least one of the glove bases.

In accordance with one or more embodiments of the invention, the agricultural product management system further includes a notification unit which is configured to indicate the curvature information or the color information of each of the agricultural products or the operation process result.

In accordance with one or more embodiments of the invention, the notification unit is arranged in the agricultural product detection device.

In accordance with one or more embodiments of the invention, the processing unit is further configured to transmit the operation process result to the agricultural product detection device through the processing device communication unit, such that the notification unit indicates the operation process result.

In accordance with one or more embodiments of the invention, the notification unit is coupled to the information processing device or arranged in the information processing device.

In accordance with one or more embodiments of the invention, the agricultural product management system further includes a data storage unit which is configured to store the curvature information or the color information of the agricultural products or the operation process result.

Another aspect of the invention is to provide an agricultural product management method. In the agricultural product management method, an agricultural product detection device is provided first which includes at least one flex sensing unit and at least one color sensing unit. The agricultural product detection device is then used to perform shape sensing and color sensing on agricultural products to obtain curvature information and color information of each of the agricultural products. A processing unit is then used to perform an operation process on the curvature information and the color information of each of the agricultural products and to generate an operation process result corresponding to each of the agricultural products accordingly.

In accordance with one or more embodiments of the invention, the agricultural product management method further includes using the processing unit to determine a category to which each of the agricultural products belongs among a plurality of categories based on the operation process result and grading rule information corresponding to the agricultural products.

In accordance with one or more embodiments of the invention, the agricultural product detection device is provided to further include a pressure sensing unit which is configured to preform weight sensing on the agricultural products to obtain a weight information of each of the agricultural products, and the processing unit is configured to perform the operation process on the curvature information, the color information and the weight information of each of the agricultural products and to generate the operation process result accordingly.

In accordance with one or more embodiments of the invention, the agricultural product management method further includes indicating the curvature information or the color information of each of the agricultural products or the operation process result by a notification unit.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings.

FIG. 1 is a functional block diagram of an agricultural product detection device in accordance with some embodiments of the invention.

FIG. 2A and FIG. 2B are respectively exterior views of two opposite sides of an agricultural product detection device in accordance with some embodiments of the invention.

FIG. 3 exemplarily illustrates element arrangements of an agricultural product detection device in accordance with some embodiments of the invention.

FIG. 4 exemplarily shows a maturity clustering result obtained by using the agricultural product detection device of the invention to perform an operation process on agricultural products.

FIG. 5 exemplarily shows a quality clustering result obtained by using the agricultural product detection device of the invention to perform an operation process on agricultural products.

FIG. 6 is a schematic diagram of an agricultural product management system in accordance with some embodiments of the invention.

FIG. 7 is a functional block diagram of an information processing device in accordance with some embodiments of the invention.

### DETAILED DESCRIPTION

The detailed explanation of the invention is described as following. The described preferred embodiments are presented for purposes of illustrations and description, and they are not intended to limit the scope of the invention.

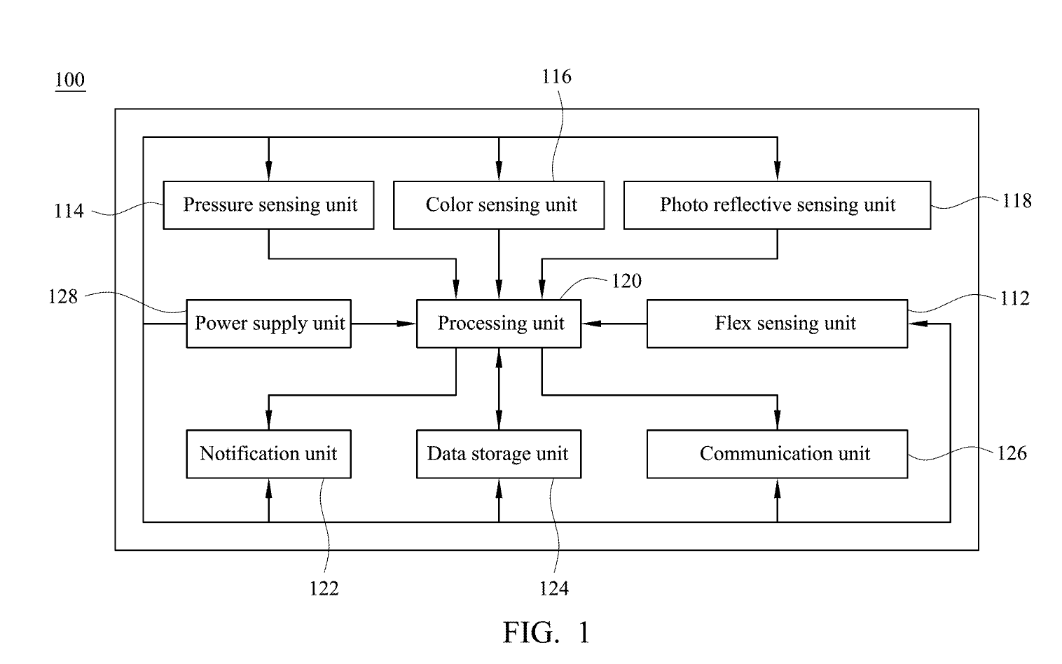

Referring to FIG. 1, FIG. 1 is a functional block diagram of an agricultural product detection device 100 in accordance with some embodiments of the invention. As shown in FIG. 1, the agricultural product detection device 100 may include a flex sensing unit 112, a pressure sensing unit 114, a color sensing unit 116, a photo reflective sensing unit 118, a processing unit 120, a notification unit 122, a data storage unit 124, a communication unit 126 and a power supply unit 128.

The flex sensing unit 112 is configured to perform shape sensing on the agricultural product, so as to obtain curvature information of the agricultural product. The flex sensing unit 112 may be a resistive flex sensor, in which the resistance is relevant to the degree of bend, and therefore the curvature information of the agricultural product can be obtained based on the resistance of the flex sensing unit 112. In some other embodiments, an optical band sensor or a piezoelectric flex sensor may also be adopted.

The pressure sensing unit 114 is configured to perform sensing on the agricultural product, so as to obtain weight information of the agricultural product. The pressure sensing unit 114 may be a resistive pressure sensor, in which the resistance is relevant to the degree of pressure exerted by an object, and therefore the weight information of the agricultural product can be obtained based on the resistance of the pressure sensing unit 114. In some other embodiments, a pneumatic pressure sensor may also be adopted.

The color sensing unit 116 is configured to perform color sensing on the agricultural product, so as to obtain color information of the agricultural product. The color sensing unit 116 may emit light source which includes three primary colors of light (i.e. red, green and blue light) and receive reflective light from the surface of the agricultural product, so as to convert the received reflective light into the color information of the agricultural product. The obtained color information may be RGB color space information, HSV color space information, YUB color space information, YCbCr color space information or information of another color space. In some embodiments, the color sensing unit 116 may directly receive reflective light of environment light from the surface of the agricultural product, and does not need to emit light by itself.

The photo reflective sensing unit 118 is configured to perform reflective light sensing on the agricultural product, so as to obtain photo reflective information of the agricultural product. The photo reflective sensing unit 118 may be an infrared sensor which can emit and receive infrared light, so as to determine if there is an agricultural product under detection based on the strength of reflected infrared light.

The processing unit 120 is coupled to the flex sensing unit 112, the pressure sensing unit 114, the color sensing unit 116 and the photo reflective sensing unit 118 and performs an operation process on the curvature information, the weight information, the color information and the photo reflective information of the agricultural product respectively obtained by the flex sensing unit 112, the pressure sensing unit 114, the color sensing unit 116 and the photo reflective sensing unit 118 and generates an operation process result accordingly. If the strength of reflected infrared light indicates there is an agricultural product under detection, the processing unit 120 increases an agricultural product detection count and determines the category to which the agricultural product belongs based on the operation process result and grading rule information corresponding to the agricultural product. In addition, the processing unit 120 may generate shape information and maturity information of the agricultural product based on the operation process result, in which the shape information may include the size and the color depth of the agricultural product, and the maturity information may include the weight of the agricultural product. In some embodiments, the processing unit 120 may further perform statistical calculation on the agricultural products to generate a maturity clustering result of the agricultural products, and may perform clustering calculation on the agricultural products to generate a quality clustering result of the agricultural products. The algorithm used by the processing unit 120 can be any algorithm suitable for performing statistical calculation and clustering calculation to the agricultural products, such as a weighted arithmetic mean algorithm, a K-means clustering algorithm and/or another suitable algorithm. The processing unit 120 may be, for example, a conventional processor, a digital signal processor (DSP), a microprocessor, an application-specific integrated circuit (ASIC), but is not limited thereto.

The notification unit 122 is configured to indicate the curvature information, the color information, the operation process result, the detection count, the shape information, the maturity information and/or the detection count of the agricultural product and/or the category to which the agricultural product belongs. The notification unit 122 may indicate the curvature information, the color information and/or the operation process result of the agricultural product and/or the category to which the agricultural product belongs by images, colors, sounds, vibrations or other ways. The notification unit 122 may be a display, an indicator lamp, a sound player, a vibrator, but is not limited thereto.

For example, the grading rule information of the agricultural product may include four levels “excellent”, “great”, “good” and “fair” and the grading rule information respectively corresponding to the levels. If the operation process result of the agricultural product detected by the agricultural product detection device 100 meets the grading rule information corresponding to the level “excellent”, the processing unit 120 determines that the category to which the agricultural product belongs is the level “excellent”. In addition, if the notification unit 122 is a display, the notification unit 122 may display the word “excellent” or any image which can let the user to recognize directly that the category to which the agricultural product belongs is the level “excellent”.

The data storage unit 124 is configured to store the curvature information and the color information of the agricultural product, the operation process result, the grading rule information, the detection count and/or the category to which the agricultural product belongs. The data storage unit 124 may be a storage device adapted to store electronic data, such as a random access memory (RAM), a USB flash drive, a secure digital (SD) memory card, a magnetic tape, a hard disk, a solid state disk (SSD), a flash memory, but is not limited thereto.

The communication unit 126 is configured to transmit the curvature information, the color information, the operation process result, the grading rule information of the agricultural product and/or the category to which the agricultural product belongs to an external system. The communication unit 126 may be an interface that adopts any wired communication technology (e.g. USB, twisted pair, cable) or wireless wired communication technology (e.g. infrared radiation, WiFi, Bluetooth) to perform data transmission.

The power supply unit 128 is configured to provide power to the flex sensing unit 112, the pressure sensing unit 114, the color sensing unit 116, the photo reflective sensing unit 118, the processing unit 120, the notification unit 122, the data storage unit 124 and the communication unit 126. The power supply unit 128 may be an element that can provide power, such as a solar cell, a lithium battery, a mercury battery or a zinc-carbon battery, but is not limited thereto.

In some embodiments, the agricultural product detection device 100 may further include a power receiving interface (not shown) which is configured to receive power from an external power source for charging the power supply unit 128 and/or providing power to the flex sensing unit 112, the pressure sensing unit 114, the color sensing unit 116, the photo reflective sensing unit 118, the processing unit 120, the notification unit 122, the data storage unit 124 and the communication unit 126. The power receiving interface (not shown) may be any interface which uses wired power transmission technology or wireless power transmission technology (e.g. electromagnetic induction). In some other embodiments, the agricultural product detection device 100 may only include the power receiving interface (not shown) but does not include the power supply unit 128, and is configured to connect an external power source, so as to provide power to the flex sensing unit 112, the pressure sensing unit 114, the color sensing unit 116, the photo reflective sensing unit 118, the processing unit 120, the notification unit 122, the data storage unit 124 and the communication unit 126 from the external power source. In some embodiments, the communication unit 126 may have functions of the power receiving interface (not shown), i.e. the power receiving interface (not shown) may be the communication unit 126.

In some embodiments, if the sensing result of flex sensing unit 112, the pressure sensing unit 114, the color sensing unit 116 and/or the photo reflective sensing unit 118 is abnormal or the communicative connection status of the communication unit 126 is abnormal or the electric quantity of the power supply unit 128 is insufficient, the processing unit 120 may control the notification unit 122 to indicate corresponding information, in order to notify the user to perform a corresponding operation, for example, repeating the detection by using the agricultural product detection device 100, checking the communicative connection status of the agricultural product detection device 100 or charging the agricultural product detection device 100.

In some embodiments, the agricultural product detection device 100 may use the color sensing unit 116 to perform photo reflective sensing, so as to determine if there is an agricultural product under detection based on the strength of reflected infrared light. The color sensing unit 116 may perform visible light reflective detection or infrared light reflective detection on the agricultural products, so as to determine if there is an agricultural product under detection based on the strength of reflected infrared light or reflected visible light. In such case, the functions of the photo reflective sensing unit 118 may be replaced by the color sensing unit 116, and the photo reflective sensing unit 118 may be removed from the agricultural product detection device 100; that is, the agricultural product detection device 100 may be provided without the photo reflective sensing unit 118.

In addition, in some embodiments, the curvature information, the weight information, the color information and/or the photo reflective information of the agricultural products respectively obtained by the flex sensing unit 112, the pressure sensing unit 114, the color sensing unit 116, the photo reflective sensing unit 118 may be transmitted to an external system (e.g. a cloud server) through the communication unit 126, and the operation process result and/or the grading rule information corresponding to the agricultural product may be received from an external system through the communication unit 126. That is, an external system communicatively connected with the agricultural product detection device 100 may perform an operation process to the curvature information, the weight information, the color information and the photo reflective information of the agricultural product and generate the operation process result and determine the category to which the agricultural product belongs, and then transmits the operation process result and/or the grading rule information corresponding to the agricultural product to the agricultural product detection device 100. The notification unit 122 of the agricultural product detection device 100 may indicate the received operation process result or the category to which the agricultural product belongs.

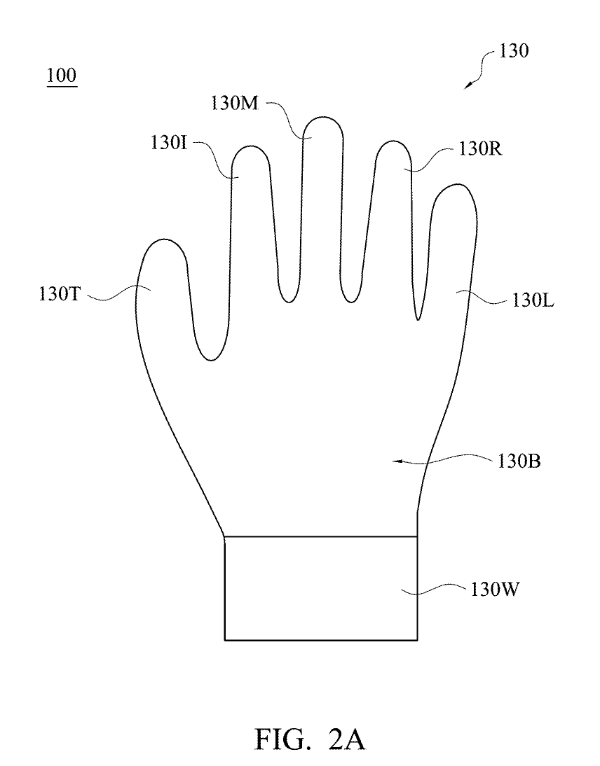

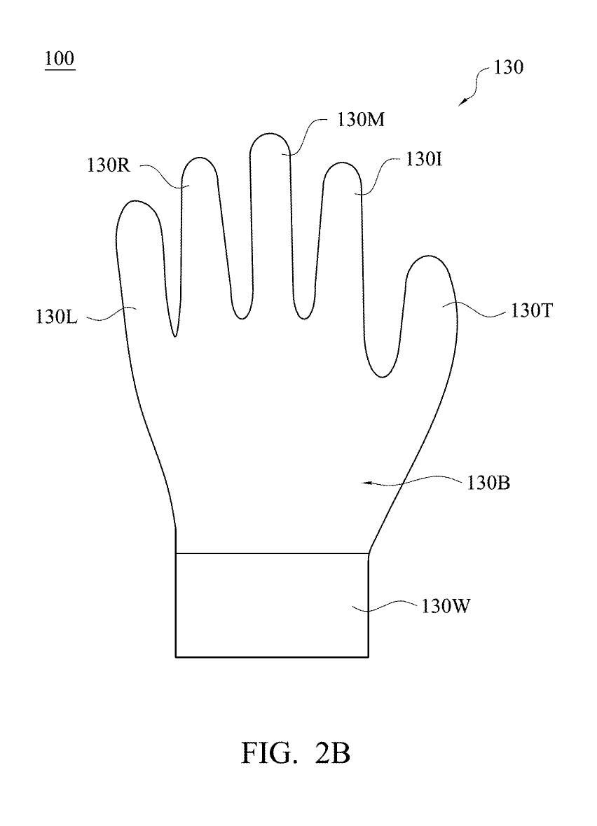

Referring to FIG. 2A and FIG. 2B simultaneously, FIG. 2A and FIG. 2B illustrate a back-side exterior view and a front-side exterior view of the agricultural product detection device 100 in FIG. 1, respectively. As shown in FIG. 2A and FIG. 2B, the agricultural product detection device 100 may has a glove shape and is adapted to be worn on a user's hand. The agricultural product detection device 100 includes a glove base 130 which is separated into an opisthenar portion 130B, a palm portion 130P, finger portions (including a thumb finger portion 130T, an index finger portion 1301, a middle finger portion 130M, a ring finger portion 130R and a little finger portion 130L) and a wrist portion 130W. The thumb finger portion 130T, the index finger portion 1301, the middle finger portion 130M, the ring finger portion 130R, the little finger portion 130L and the wrist portion 130W all has a front side that neighbors the palm portion 130P and a back side that neighbors the opisthenar portion 130B. The glove base 130 may include a material of polyester, nylon, cotton, a combination thereof or another similar material, and has spaces for accommodating the flex sensing unit 112, the pressure sensing unit 114, the color sensing unit 116, the photo reflective sensing unit 118, the processing unit 120, the notification unit 122, the data storage unit 124, the communication unit 126, the power supply unit 128 and/or other electronic components. The glove base 130 has waterproof, dustproof and shockproof functions for protecting the electronic components arranged in the glove base 130. In addition, the material and structure of each portion of the glove base 130 may be designed in accordance with various requirements. For example, the wrist portion 130W may be designed to have a hook and loop fastening structure to facilitate the user to wear and fix the agricultural product detection device 100 on his hand and to take off the agricultural product detection device 100 from his hand.

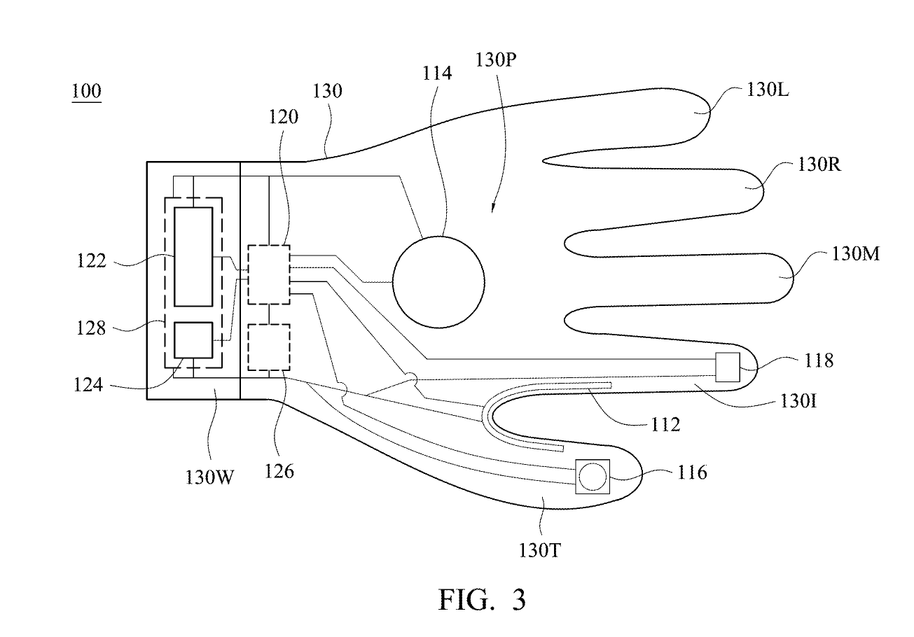

FIG. 3 exemplarily illustrates element disposal of the agricultural product detection device 100. As shown in FIG. 3, the flex sensing unit 112 is disposed between the thumb finger portion 130T and the index finger portion 1301, the pressure sensing unit 114 is disposed at the palm portion 130P, the color sensing unit 116 is disposed at the thumb finger portion 130T, the photo reflective sensing unit 118 is disposed at the index finger portion 1301, the processing unit 120 and the communication unit 126 are disposed at the opisthenar portion 130B, and the notification unit 122, the data storage unit 124 and the power supply unit 128 are disposed at the wrist portion 130W. Each of the elements may be disposed at an exterior portion, an inner portion or an interlayer of the glove base 130.

The arranged positions of the flex sensing unit 112, the pressure sensing unit 114, the color sensing unit 116 and the photo reflective sensing unit 118 can be non-overlapped. In addition, the photo receiving side of the color sensing unit 116 and the photo reflective sensing unit 118 may be arranged external to the glove base 130 rather than covered by the glove base 130, so as to enhance the sensitivity of the color sensing unit 116 and the photo reflective sensing unit 118. In some other embodiments, the glove base 130 may cover the color sensing unit 116 and the photo reflective sensing unit 118, and the portion of the glove base 130 which covers the color sensing unit 116 and the photo reflective sensing unit 118 may be formed of a transparent material, in order to facilitate the color sensing unit 116 and the photo reflective sensing unit 118 to receive reflective light from the agricultural product.

It is noted that, besides the disposal aspect of each element shown in FIG. 3, the agricultural product detection device of the invention may also have other different element disposal aspects. For example, multiple color sensing unit and/or multiple flex sensing units may be disposed in the agricultural product detection device of the invention. In addition, in the invention, the arranged position of each of the components in the glove base of the agricultural product detection device may be adjusted in accordance with various requirements, but is not limited to the arranged position of each of the components illustrated in FIG. 3. For example, the photo reflective sensing unit 118 may be arranged at the palm portion 130P, and the processing unit 120 and the communication unit 126 may be modified to be disposed at the wrist portion 130W. Accordingly, any position of each of the components of the agricultural product detection device arranged in the glove base is in the scope of the invention.

Further, in the invention, the shape design of the glove base of the agricultural product detection device can also be modified in accordance with various requirements and is not limited to that shown in FIG. 2A and FIG. 2B. For example, if there is no component arranged at the middle finger portion, the ring finger portion and the little finger portion of the glove base, the middle finger portion, the ring finger portion and the little finger portion of the glove base can be removed. As shown in FIG. 3, the flex sensing unit 112 is disposed at the thumb finger portion 130T and the index finger portion 1301 of the glove base 130, the color sensing unit 116 is disposed at the index finger portion 1301 of the glove base 130, and no components are arranged at the middle finger portion 130M, the ring finger portion 130R and the little finger portion 130L of the glove base 130, and therefore the middle finger portion 130M, the ring finger portion 130R and the little finger portion 130L of the glove base 130 can be removed. That is, the glove base 130 in FIG. 3 may only include the thumb finger portion 130T and the index finger portion 1301 but does not include the middle finger portion 130M, the ring finger portion 130R and the little finger portion 130L.

In some other embodiments of the invention, the agricultural product detection device may include two glove bases which are adapted to be worn on two hands of a user, and the flex sensing unit and the color sensing unit can be respectively arranged in at least one of the glove bases.

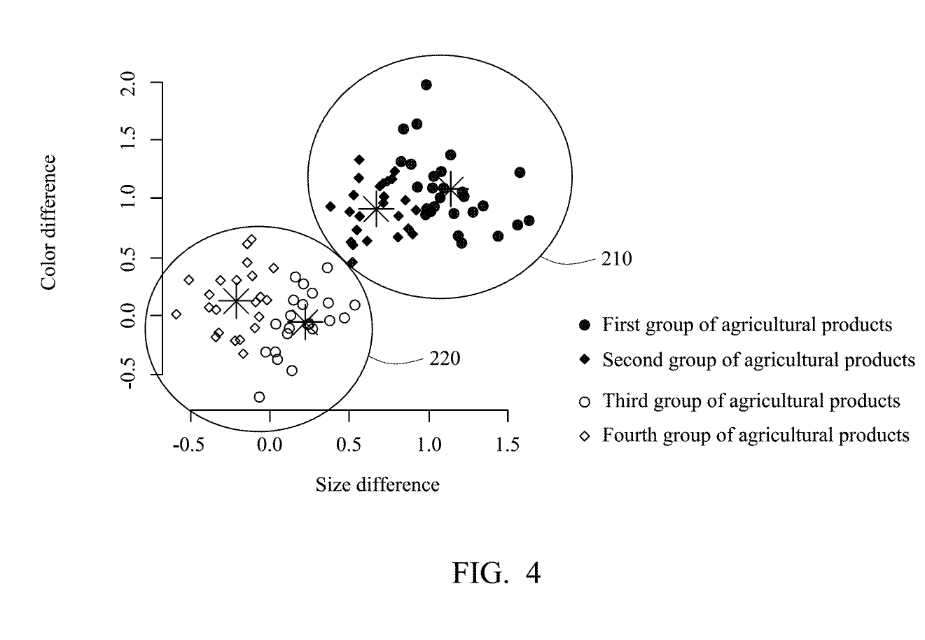

FIG. 4 exemplarily shows a maturity clustering result obtained by using the agricultural product detection device 100 to perform an operation process on the agricultural products. In FIG. 4, the horizontal axis represents the size difference of the plan diameter of the agricultural product subtracted from a predetermined plan diameter standard value, while the vertical axis is the color difference of the value of the agricultural product in a HSV color space subtracted from a predetermined value standard value. For the first and second group of agricultural products, the coordinate points corresponding to the results after performing a statistical operation process on the curvature information and the color information of the first group of agricultural products and the second group of agricultural products in a region 210 of the coordinate space shown in FIG. 4, in which the region 210 corresponds to the part in which the agricultural product can be harvested. Oppositely, for the third and fourth group of agricultural products, the coordinate points corresponding to the calculated clustering results after performing a statistical operation process on the curvature information and the color information of the first group of agricultural products and the second group of agricultural products in a region 220 of the coordinate space shown in FIG. 4, in which the region 220 corresponds to the part in which the agricultural product still cannot be harvested. In this example, the notification unit 122 of the agricultural product detection device 100 may indicate that the first and second group of agricultural products can be harvested but the third and fourth group of agricultural products still cannot be harvested.

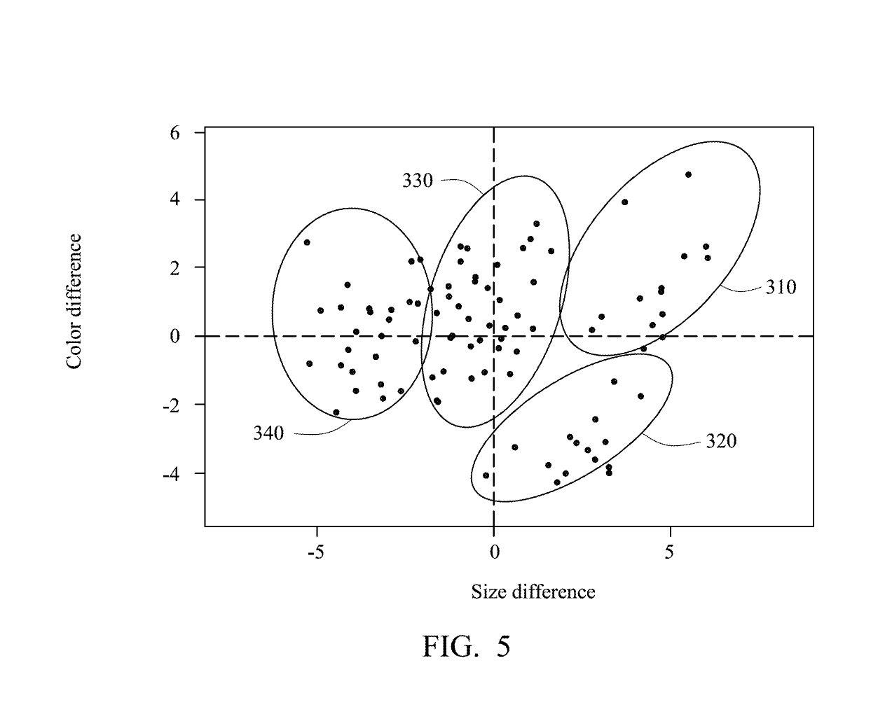

In addition, FIG. 5 exemplarily shows a quality clustering result obtained by using the agricultural product detection device 100 to perform an operation process on the agricultural products. In FIG. 5, the horizontal axis represents the size difference of the plan diameter of the agricultural product subtracted from a predetermined plan diameter standard value, while the vertical axis is the color difference of the value of the agricultural product in a HSV color space subtracted from a predetermined value standard value. The results after performing an operation process on the curvature information and the color information of the agricultural products correspond to the coordinate points of the coordinate space shown in FIG. 5. These coordinate points are processed by a clustering operation process is then performed, so as to obtain the categories to which the agricultural product belong, and the notification unit 122 of the agricultural product detection device 100 may indicate the categories to which the agricultural products belong. As shown in FIG. 5, the coordinate points of the agricultural products are located in the regions 310, 320, 330 and 340, respectively, and the regions 310, 320, 330 and 340 respectively correspond to four levels “excellent”, “great”, “good” and “fair”. In the example, the notification unit 122 of the agricultural product detection device 100 may the levels corresponding to the agricultural products.

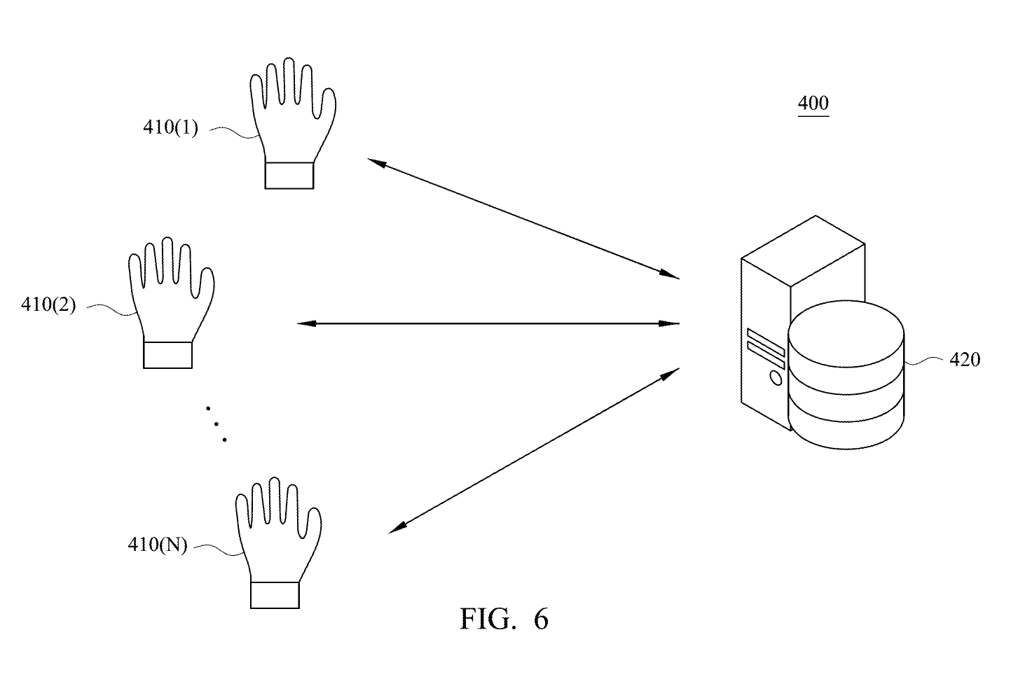

FIG. 6 is a schematic diagram of an agricultural product management system 400 in accordance with some embodiments of the invention. As shown in FIG. 6, the agricultural product management system 400 includes agricultural product detection devices 410(1)-410(N) and an information processing device 420. Each of the agricultural product detection devices 410(1)-410(N) may be the agricultural product detection device 100 in FIG. 1 or another similar detection device. The information processing device 420 may be communicatively connected with the agricultural product detection devices 410(1)-410(N), by wired communication technology, wireless communication technology or combinations thereof. The information processing device 420 has data processing functions, which can be a personal computer, a notebook computer, a tablet computer, a smartphone or a cloud server, but is not limited thereto.

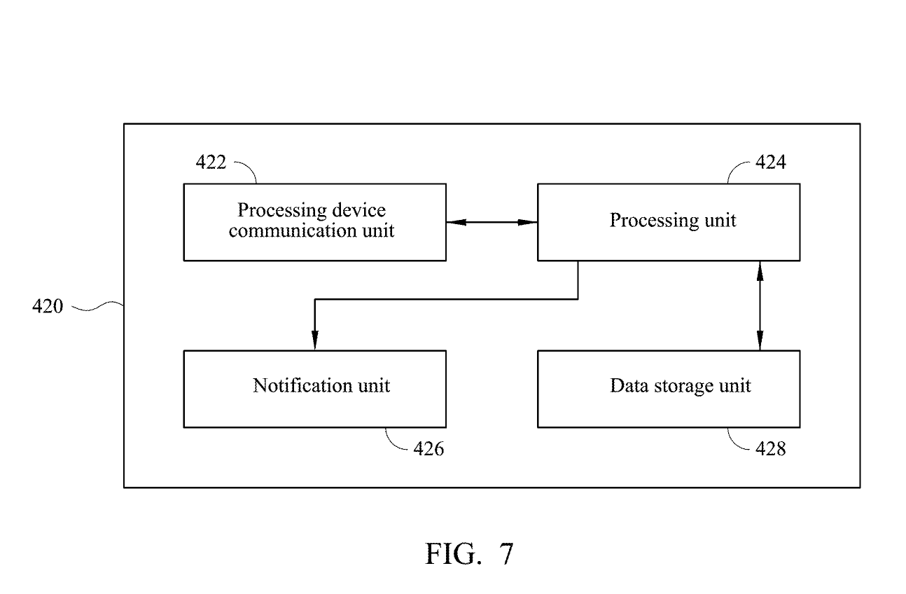

FIG. 7 is a functional block diagram of the information processing device 420. As shown in FIG. 7, the information processing device 420 includes a processing device communication unit 422, a processing unit 424, a notification unit 426 and a data storage unit 428.

The processing device communication unit 422 is configured to receive curvature information, color information, weight information and/or photo reflective information of the agricultural products from the agricultural product detection devices 410(1)-410(N). The processing device communication unit 422 may be an interface that adopts any wired communication technology (e.g. USB, twisted pair, DSL, cable) or wireless wired communication technology (e.g. infrared radiation, WiFi, 3G or 4G mobile communication, Bluetooth) to perform data transmission.

The processing unit 424 is configured to perform an operation process on the curvature information, the weight information, the color information and the photo reflective information received from the agricultural product detection devices 410(1)-410(N) and to generate an operation process result accordingly. If the strength of reflected infrared light indicates there is an agricultural product under detection, the processing unit 424 increases an agricultural product detection count and determines the category to which the agricultural product belongs based on the operation process result and grading rule information corresponding to the agricultural product. In addition, the processing unit 424 may generate the shape information and the maturity information of the agricultural product based on the operation process result, in which the shape information may include the size, the color depth and the surface gloss of the agricultural product, and the maturity information may include the weight, the specific gravity and the surface hardness of the agricultural product. In some embodiments, the processing unit 424 may further perform statistical calculation on the agricultural products to generate a maturity clustering result of the agricultural products, and may perform clustering calculation on the agricultural products to generate a quality clustering result of the agricultural products. The algorithm used by the processing unit 424 can be any algorithm suitable for performing statistical calculation and clustering calculation to the agricultural products, such as a weighted arithmetic mean algorithm, a K-means clustering algorithm and/or another suitable algorithm. In addition, the processing unit 424 may further transmit the operation process result, the detection count, the shape information and/or the maturity information of the agricultural products and/or the categories to which the agricultural products belong to the corresponding agricultural product detection devices 410(1)-410(N) or another external electronic device or system through the processing device communication unit 422, so as to indicate the operation process result, the detection count, the shape information and/or the maturity information of the agricultural products and/or the categories to which the agricultural products belong at the corresponding agricultural product detection devices 410(1)-410(N) or another external electronic device or system. The processing unit 424 may be, for example, conventional processor, a DSP, a microprocessor, an ASIC, but is not limited thereto.

The notification unit 426 is configured to indicate the curvature information, the color information, the operation process result, the detection count, the shape information, the maturity information and/or the detection count of the agricultural products and/or the category to which each of the agricultural products belongs. The notification unit 426 may indicate the curvature information, the color information and/or the operation process result of the agricultural products and/or the category to which each of the agricultural products belongs by images, colors, sounds, vibrations or other ways. The notification unit 426 may be a display, an indicator lamp, a sound player, a vibrator, but is not limited thereto. In some other embodiments, the notification unit 426 may be disposed external to the information processing device 420 and coupled to or communicatively connected to the information processing device 420.

The data storage unit 428 is configured to store the curvature information, the color information, the operation process result, the grading rule information, the shape information, the maturity information and/or the detection count of the agricultural products and/or the category to which each of the agricultural products belongs. In addition, in some embodiments, the algorithm used by the processing unit 424 may be compiled into a program code, and the compiled program code may be stored in the data storage unit 428. The data storage unit 428 may be a storage device adapted to store electronic data, such as a RAM, a USB flash drive, an SD memory card, a magnetic tape, a hard disk, an SSD, a flash memory, but is not limited thereto.

As can be seen from the above description, the agricultural product detection device of the invention can facilitate performing real-time detection on the quality of agricultural products when harvesting and classifying the agricultural products and can improve accuracy of agricultural product classification. In addition, the agricultural product management system and method of the invention can at least facilitate management of agricultural products, for example, automatically importing curvature information, color information, an operation process result, a detection count, shape information and/or maturity information of the agricultural products and/or categories to which the agricultural products belong into an inventory system, or generating information such as an agricultural product harvest time and a harvest quantity of the corresponding categories based on the abovementioned information, so as to facilitate evaluation of the agricultural product harvest time, the harvest quantity and the quality distribution of future seasons.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims.

What is claimed is:

1. An agricultural product detection device, comprising:
at least one flex sensing unit configured to perform shape sensing on an agricultural product, so as to obtain at least one curvature information of the agricultural product;
at least one color sensing unit configured to perform color sensing on the agricultural product, so as to obtain at least one color information of the agricultural product; and
a processing unit coupled to the at least one flex sensing unit and the at least one color sensing unit, the processing unit configured to perform an operation process on the at least one curvature information and the at least one color information and to generate an operation process result accordingly.

2. The agricultural product detection device of claim 1, wherein the processing unit is configured to determine a category to which the agricultural product belongs based on the operation process result and a grading rule information corresponding to the agricultural product.

3. The agricultural product detection device of claim 1, further comprising:
a glove base adapted to be worn on a hand of a user, wherein the at least one flex sensing unit, the at least one color sensing unit and the processing unit are arranged in the glove base.

4. The agricultural product detection device of claim 1, further comprising:
a pressure sensing unit configured to perform weight sensing on the agricultural product, so as to obtain a weight information of the agricultural product;
wherein the processing unit is configured to perform the operation process on the at least one curvature information, the at least one color information and the weight information to generate the operation process result accordingly.

5. The agricultural product detection device of claim 1, further comprising:
a notification unit configured to indicate the at least one curvature information, the at least one color information or the operation process result.

6. The agricultural product detection device of claim 1, further comprising:
a data storage unit configured to store the at least one curvature information, the at least one color information or the operation process result.

7. An agricultural product management system, comprising:
an agricultural product detection device configured to be worn on at least one hand of a user, wherein the agricultural product detection device comprises:
at least one flex sensing unit configured to perform shape sensing on agricultural products, so as to obtain at least one curvature information of each of the agricultural products;
at least one color sensing unit configured to perform color sensing on the agricultural products, so as to obtain at least one color information of each of the agricultural products; and
a detection device communication unit configured to transmit the at least one curvature information and the at least one color information of each of the agricultural products; and
an information processing device, comprising:
a processing device communication unit configured to be communicatively connected with the detection device communication unit and to receive the at least one curvature information and the at least one color information of each of the agricultural products from the agricultural product detection device; and
a processing unit configured to receive the at least one curvature information and the at least one color information of each of the agricultural products and to perform an operation process on the at least one curvature information and the at least one color information of each of the agricultural products and to generate an operation process result accordingly.

8. The agricultural product management system of claim 7, wherein the processing unit is configured to determine a category to which each of the agricultural products belongs among a plurality of categories based on the operation process result and at least one grading rule information corresponding to the agricultural products.

9. The agricultural product management system of claim 7, wherein the processing unit is configured to generate a shape information and a maturity information of each of the agricultural products based on the operation process result and to record the shape information and the maturity information of each of the agricultural products.

10. The agricultural product management system of claim 7, wherein the agricultural product detection device further comprises:
a pressure sensing unit configured to perform weight sensing on the agricultural products, so as to obtain a weight information of each of the agricultural products;
wherein the processing unit is further configured to perform the operation process on the at least one curvature information, the at least one color information and the weight information of each of the agricultural products and to generate the operation process result accordingly.

11. The agricultural product management system of claim 7, wherein the agricultural product detection device comprises two glove bases which are adapted to be respectively worn on two hands of the user, wherein the at least one flex sensing unit is arranged in at least one of the glove bases, and wherein the at least one color sensing unit is arranged in at least one of the glove bases.

12. The agricultural product management system of claim 7, further comprising:
a notification unit configured to indicate the at least one curvature information or the at least one color information of each of the agricultural products or the operation process result.

13. The agricultural product management system of claim 12, wherein the notification unit is arranged in the agricultural product detection device.

14. The agricultural product management system of claim 13, wherein the processing unit is further configured to transmit the operation process result to the agricultural product detection device through the processing device communication unit, such that the notification unit indicates the operation process result.

15. The agricultural product management system of claim 12, wherein the notification unit is coupled to the information processing device or arranged in the information processing device.

16. The agricultural product management system of claim 7, further comprising:
a data storage unit configured to store the at least one curvature information or the at least one color information of the agricultural products or the operation process result.

17. An agricultural product management method, comprising:
providing an agricultural product detection device, wherein the agricultural product detection device comprises at least one flex sensing unit and at least one color sensing unit;
using the agricultural product detection device to perform shape sensing and color sensing on agricultural products, so as to obtain at least one curvature information and at least one color information of each of the agricultural products; and
using a processing unit to perform an operation process on the at least one curvature information and the at least one color information of each of the agricultural products and to generate an operation process result corresponding to each of the agricultural products accordingly.

18. The agricultural product management method of claim 17, further comprising:
using the processing unit to determine a category to which each of the agricultural products belongs among a plurality of categories based on the operation process result and at least one grading rule information corresponding to the agricultural products.

19. The agricultural product management method of claim 17, wherein the agricultural product detection device is provided to further comprise a pressure sensing unit, wherein the pressure sensing unit is configured to preform weight sensing on the agricultural products, so as to obtain a weight information of each of the agricultural products, and wherein the processing unit is configured to perform the operation process on the at least one curvature information, the at least one color information and the weight information of each of the agricultural products and to generate the operation process result accordingly.

20. The agricultural product management method of claim 17, further comprising:
indicating the at least one curvature information or the at least one color information of each of the agricultural products or the operation process result by a notification unit.
